(19) United States
(12) Patent Application Publication
(10) Pub. No.: US 2012/0005113 A1
(43) Pub. Date: Jan. 5, 2012

(54) SYSTEM AND METHOD FOR ASSESSING EMPLOYEE WORK PERFORMANCE

(75) Inventor: Constantine Kotis, Point Piper (AU)

(73) Assignee: LIFEHISTORY PTY LTD, Coogee (AU)

(21) Appl. No.: 13/147,077

(22) PCT Filed: Dec. 24, 2009
(86) PCT No.: PCT/AU2009/001709

§ 371 Date: Sep. 23, 2011

(30) Foreign Application Priority Data
Jan. 29, 2009 (AU) 2009900316

(51) Int. Cl. G06Q 10/00

(52) U.S. Cl. 705/321

(57) ABSTRACT

A computer system for maintaining employee performance ratings, the system comprising a storage module configured to store an employee record comprising employee performance data, the performance data generated in response to an evaluation made by an associated employer. The system further comprising a determination module arranged to evaluate both the stored employee performance data and predefined performance criteria to determine a performance rating for the employee. A publishing module is provided for publishing the employee performance rating which is viewable by authorised third parties via a computer network.

### TECHNICAL FIELD

This present invention relates generally to a system and method for maintaining a performance database and more particularly but by no means exclusively to an employee work performance system.

### BACKGROUND OF THE INVENTION

It is not always easy finding the right person for the job. While interviewing a candidate may go some way to providing a prospective employer with an insight into the candidate's work capabilities and general demeanour, the interview process is not an effective tool for establishing whether the candidate has a good work ethic and will treat the job with respect.

The most common way to establish whether a potential candidate has a good work ethic is to contact work referees listed on the candidate's resume. However, the task of phoning referees and discussing a candidate's work history can be very time consuming (particularly when interviewing a large number of candidates). Furthermore, since the referees are nominated by the candidate they will typically provide little insight into the candidate's true work ethic since the candidate is unlikely to nominate referees with whom they have had a less than positive experience.

### SUMMARY OF THE INVENTION

In a first aspect the present invention provides a method for maintaining an employee performance database, the method comprising the steps of:
utilising performance data associated with an employee to determine a performance rating for the employee, the performance data generated in response to an evaluation made by an associated employer; and
storing the performance rating for the employee in a database accessible to a third party.

In accordance with a second aspect of the present invention there is provided a method for maintaining an employee performance database, the method comprising:
storing an employee record comprising employee performance data, the performance data generated in response to an evaluation made by an associated employer;
evaluating the performance data and predefined performance criteria to determine a performance rating for the employee; and
publishing the employee performance rating, the published performance rating being viewable by authorised parties via a computer network.

In the context of the specification, the term “employee” will be understood as referring to any individual or entity that is either currently employed or has previously been employed by the associated employer. The term may, for example, include within its scope a contractor, small business, or the like. Equally, the rating assigned by the associated employer may be assigned while the employee is currently under their employ or at some later stage after the employee has ceased working for the employer.

Furthermore, it will be understood that the term “third party” includes within its scope any party outside of or in addition to the employer/employee confines. For example, the third party may be a prospective employer looking to employ the employee. In an embodiment access restrictions may apply such that only authorised third parties can access the database.

In an embodiment the evaluation made by the employer evaluates at least one performance characteristic.

In an embodiment the performance characteristics include one or more of worker ethic; timeliness, attention to detail; management skills.

In an embodiment the evaluation comprises completing a questionnaire including at least one question pertinent to the performance characteristic(s).

In an embodiment the question(s) are multiple choice with each answer being assigned a particular score.

In an embodiment the method further comprises automatically generating the questionnaire based on a job characteristic associated with the employee.

In an embodiment the performance rating is determined by evaluating the scores resulting from the evaluation.

In an embodiment the method further comprises evaluating bonus criteria in order to determine a bonus score, both the bonus score and the score resulting from the evaluation being evaluated to determined the performance rating.

In an embodiment the performance characteristics vary depending on at least one of the employee's job type, pay level and duration of employment.

In an embodiment a prospective employer or employee or other interested party pays a fee to access and search the database for employee ratings.

In an embodiment the prospective employer/employee/interested party has access to the database for a period dependent on the fee paid.

In an embodiment the rating is a star rating.

In an embodiment the database is maintained by a network entity separate to the employer.

In accordance with a third aspect the present invention provides a method for making employee performance, evaluations, the method comprising the steps of:
evaluating the performance of an employee;
communicating the results of the evaluation to a computing system, the results being processed by the computing system based on performance criteria to determine a performance score and/or rating for subsequent storing in a database accessible to third parties using a network enabled computer device.

In an embodiment the evaluation evaluates at least one performance characteristic.

In an embodiment the performance characteristics include one or more of worker ethic; timeliness, attention to detail; management skills.

In an embodiment the evaluation comprises answering questions automatically generated by the computing system based on a job characteristic associated with the employee.

In an embodiment the questions are multiple choice questions with each answer being assigned a particular score.

In an embodiment the performance rating is determined by evaluating the scores resulting from the evaluation.

In an embodiment the performance characteristics vary depending on at least one of the employee's job type, pay level and duration of employment.

In an embodiment the performance rating is determined by additionally evaluating a bonus score automatically generated by the computing system.

In an embodiment the centralised computing system prompts employers to make the evaluation at prescribed time periods.

In accordance with a fourth aspect the present invention provides a web server coupled to an employee performance database storing employee performance ratings derived from employee performance data provided by an employer responsive to an employee performance evaluation, the web server being configured to publish the employee performance ratings such that the published ratings are viewable by third parties over a communications network.

In accordance with a fifth aspect the present invention provides a method for recruiting staff (e.g. employees, contractors, businesses or other engaged party), the to method comprising the steps of:
utilising a graphical user interface to search the database in accordance with the third aspect, to locate employee records matching a specified search criteria;
displaying matching employee records on the graphical user interface, each returned record including the associated employee performance rating.

In accordance with a sixth aspect the present invention provides a recruitment apparatus comprising a web server in accordance with the fourth aspect;
a graphical user interface operable to allow a prospective employer to:
   (a) search the database to locate employee records matching a specified search criteria;
   (b) display the resultant employee records, each returned record including the associated employee performance rating.

In accordance with a seventh aspect the present invention provides a system for maintaining employee performance ratings, the system comprising:
a determination module arranged to utilise performance data associated with an employee to determine a performance rating for the employee, the performance data generated in response to an evaluation made by an associated employer; and
a database accessible to prospective employers and arranged to store the employee performance ratings.

In accordance with an eighth aspect the present invention provides a computer system for maintaining employee performance ratings, the system comprising:
a storage module configured to store an employee record comprising employee performance data, the performance data generated in response to an evaluation made by an associated employer;
a determination module arranged to evaluate both the stored employee performance data and predefined performance criteria to determine a performance rating for the employee; and
a publishing module publishing the employee performance rating, the published employee rating being viewable by authorised third parties via a computer network.

In an embodiment the evaluation made by the associated employer evaluates at least one performance characteristic.

In an embodiment the system is further configured to automatically generate a questionnaire for completion by the employer based on an employee job characteristic, the questionnaire forming at least part of the evaluation.

In an embodiment the automatically generated questionnaire includes at least one question which is specific to the job characteristic.

In an embodiment the performance data reflects answers to the questionnaire.

In an embodiment the questionnaire includes multiple choice questions with each answer being assigned a particular score.

In an embodiment the determination model determines the rating by evaluating the resultant scores.

In an embodiment the performance rating is determined by additionally evaluating bonus point criteria.

In an embodiment the bonus point criteria relate to data stored by the employee record independently of employee evaluations.

In an embodiment the performance characteristics vary depending on at least one of the employee's job type, pay level and duration of employment.

In accordance with a ninth aspect the present invention provides a computer implemented system for making employee performance evaluations, the system comprising:
a data recording module operable to record results of an employee performance evaluation; and
a communication module operable to communicate the recorded results as performance data to a centralised computing system for determining a performance score or rating based on the recorded results, the performance score being published on a website accessible by authorised third parties.

In accordance with a tenth aspect the present invention provides a method for making performance evaluations, the method comprising the steps of:
storing an employee record comprising employee performance data, the performance data generated in response to an evaluation made by an associated employer;
evaluating the performance data and predefined performance criteria to determine a performance rating for the employee; and
publishing the employee performance rating, the published performance rating being viewable by authorised parties via a computer network.

In an embodiment, the evaluation may additionally be based on bonus point criteria which relates to non-subjective data stored by the system.

In accordance with an eleventh aspect the present invention provides a system for maintaining entity performance ratings, the system comprising:
a determination module arranged to utilise performance data associated with an entity to determine a performance rating for the entity, the performance data generated in response to an evaluation made by an authorised party; and
a database accessible to third parties and arranged to store the entity performance ratings.

In accordance with a twelfth aspect the present invention provides a computer program code which when executed by a processor implements the method according to any of the aforementioned aspects.

In accordance with a thirteenth aspect the present invention provides a computer readable medium comprising the program code of the twelfth aspect.

### BRIEF DESCRIPTION OF THE DRAWINGS

Embodiments of the present invention will now be described, by way of example only, with reference to the accompanying drawings, in which:

FIG. 1 is a schematic showing a basic system configuration in accordance with an embodiment;

FIGS. 2a and 2b are diagrams showing various process flows, at a system level, between individual system elements and users, in accordance with an embodiment;

FIG. 3 is a flow diagram illustrating method steps for storing employee work history data, in accordance with an embodiment of the present invention;

FIG. 4 is a flow chart showing the process flow for various users of the FIG. 1 system;

FIG. 5 is a block diagram of a server arranged implement an embodiment of the present invention;

FIG. 6 is an example screen shot of a graphic user interface for the web server shown in FIG. 2; and

FIGS. 7, 8 and 9 show further example screen shots of the user interface displaying work history ratings for a particular employee.

### DETAILED DESCRIPTION OF THE PREFERRED EMBODIMENT

In an embodiment the present invention provides a database accessible by third parties (termed the “Work History” database) which is arranged to store employee performance data that is indicative of an employee's performance in a current or past job. In a particular embodiment the performance data is generated based on a performance evaluation made by an employer (either past or present) and stored in the form of a star rating. The rating is then published via a web server. A number of distinct advantages arise from such an embodiment. Firstly, the knowledge that an employee's work history is being recorded and published means that an employee is more likely to maintain a high work ethic, since a poor star rating may jeopardise future employment prospects. Other benefits arising through use of the system, from an employers perspective, may also include better training of staff, communication of expectations, discipline, supervision and accountability. From a prospective employer's perspective, the work history database can be a valuable tool for screening candidates when looking to recruit as they no longer need rely simply on written or verbal reference from referees nominated by the candidates. Thus, better candidates will be considered for recruitment meaning reduced staff turnover. Finally, hard working and diligent individuals who have been assigned a performance rating by a previous employer will find that they are more employable since a high rating will be seen favourably by the prospective employers. The employee will also benefit from having a well documented and accurate record of their work history and performance for future salary review and future employment. In other words, embodiments not only ensure that current employers are not being mistreated by their employees, but also provides prospective employers with an invaluable tool for screening candidates that have consented to having their work history recorded.

### Basic System Configuration

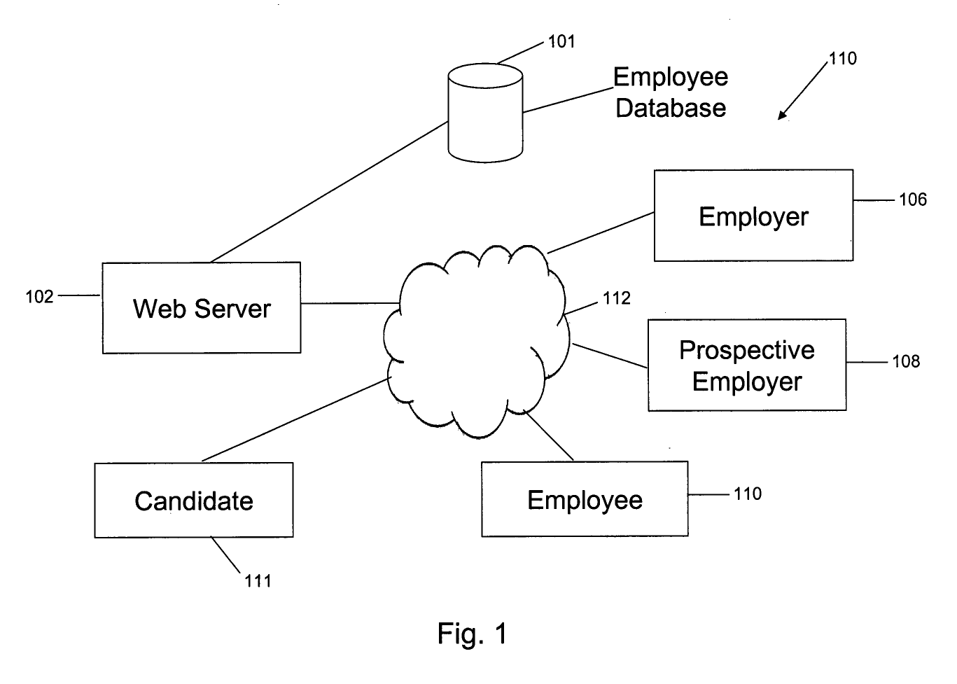

With reference to FIG. 1, there is shown a schematic illustration of a system 100 arranged to implement an embodiment of the present invention. The system 100 includes a web server 102 which maintains an employee database 104 storing employee work history data in the form of a performance rating or score provided by a past or current employer. The work history data is stored in association with an employee record (also referred to herein as “base record”). In an embodiment, the employee record may include an employee identifier (e.g. name, date of birth, drivers license, tax file number etc.) as well as their contact details. In an alternative embodiment, the employee identifier may comprise a unique number or code assigned by the system and referred to hereafter as a “work history identifier”. Employee records stored in the database 104 can be searched and retrieved, via a webpage or website hosted by the web server 102. Current employers 106, potential employers 108, employees 110 and candidates (i.e. employees out of work, or employees currently holding a job but looking for new work) 111 can each access the web page, via a computer device over communications network 112. In the illustrated embodiment, the communications network 112 is in the form of the Internet.

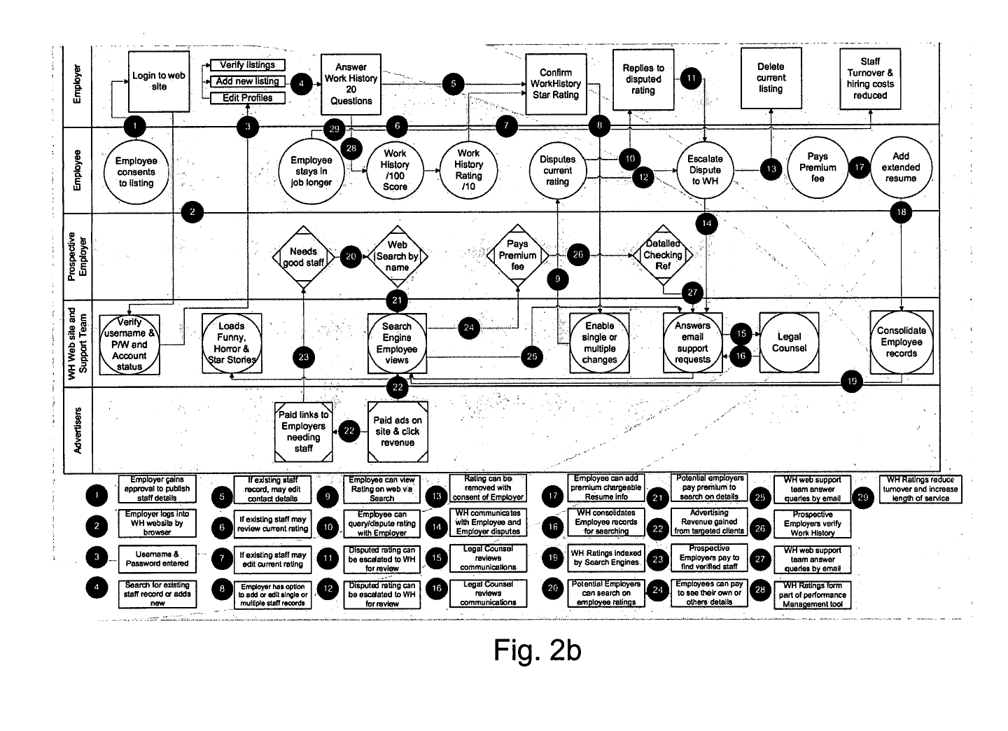

In an embodiment, and with additional reference to FIG. 3, a basic process flow for storing work history data involves an initial step of an employer (or other allowed party) making a review of a current employee's work performance (step 302). As will be described in more detail below, the review may involve answering a questionnaire that includes questions pertinent to one or more performance characteristics such as an employee's work ethic, attitude, dress, timeliness and any other performance characteristics relevant to that person's job type. The questions may be made up of either objective or subjective questions, or alternatively may comprise a mixture of both subjective and objective questions. For example, in one embodiment the questionnaire may be in the form of a Likert-type questionnaire whereby employers specify their level of agreement to a particular statement using a point scale. The point scale may, for example, be a five point scale whereby a score of “1” represents a strong disagreement to the statement and “5” represent a strong agreement to the statement. Alternatively, the questionnaire may include a number of multiple choice questions where a particular answer is assigned a rating (e.g. option “a” equates to a point score of “1”, whereas options “e” equates to a point score of “5”). More detail relating to evaluation of points and applying weightings will be described in subsequent paragraphs.

In an embodiment the same set of questions will be asked of the employer irrespective of the employee's job description. Such questions may be generic questions like, for instance, does the employee turn up to work on time, etc. In an alternative embodiment, the web server may automatically present different questionnaires based on an employee job description specified by the employer.

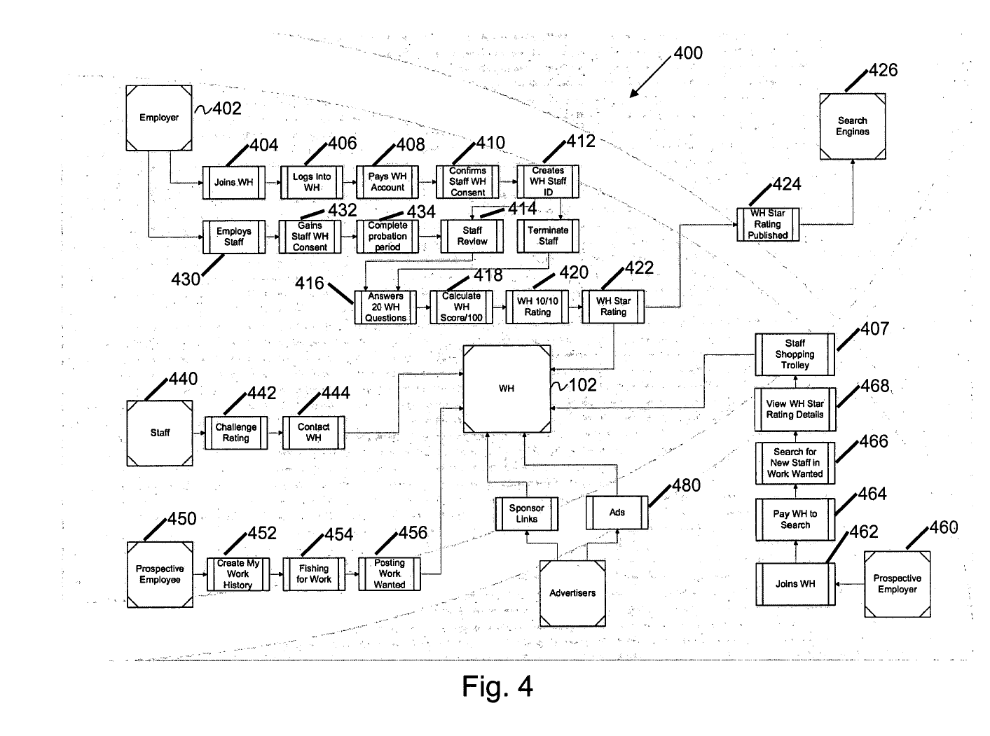

For example, it may not be appropriate to establish whether an office clerk has good management skills, whereas this may be an essential performance characteristic for an office manager. Individual questionnaires corresponding to various stored job descriptions may be stored as questionnaire data in memory 504 (see FIG. 5) for subsequent retrieval and presentation by the web server 102.

In an alternative embodiment, employers may manually choose or create at least some of the questions to include in the questionnaire. For example, the employer could select questions from a global question set provided by the web server 102. For example, assuming that the questionnaire must include a total of twenty questions under four different categories (e.g. timelines, personality, integrity, reliability), the employee may be able to select five questions from at least one category which are pertinent to the employee's job description (the remaining 15 questions being automatically selected by the system). In an embodiment, the categories may also/alternatively be selected by the employer. Again, the individual questions relating to each category may be stored as question data in memory 504. A number of example scenarios are given in subsequent paragraphs.

At step 304, the scores are tallied and a point score is determined by a determination application residing on the web server 102. In the illustrated embodiment, the employer answers twenty questions having a maximum point score of 100. In this case, a score of “100” represents a perfect employee, whereas a score of “20” represents an extremely poor employee. Bonus points are also on offer. The bonus points are automatically evaluated by the determination application based on bonus point criteria (i.e. independently of any assessment made by the employer), to thereby provide a further level of fairness to the system. In the illustrated embodiment, depending on the bonus evaluation, a total of ten points may be either added or subtracted from the questionnaire point score. The bonus point criteria may, for example, relate to the length of time that the employee has worked in their current role, the number of positive client/colleague references, the number of performance ratings given for the current job position, the average rating for the current job position and the average work history star rating across all recorded positions (also referred to as base records). Again, example scenarios are provided in subsequent paragraphs. The total score (i.e. questionnaire score and bonus score combined) is then processed by the determination application to determine an employee performance rating; in the embodiment described herein, a “star rating”. Where a five star rating is utilised, for example, the determined score will be divided by 20 (since a total of 100 points is attainable) and the resultant number applied as the star rating. If the resultant number is not a whole number then the closest whole number will be used for the assigned rating. It will be understood by persons skilled in the art that other rating mechanisms and outputs are equally applicable depending on the desired implementation. The resultant score or rating is subsequently stored in the database 104 in association with the corresponding employee record (step 306). In an alternative embodiment, the questions asked of the employer and/or their answers to the questions are also stored in the database 104 in association with the resultant score/rating for viewing by the third party.

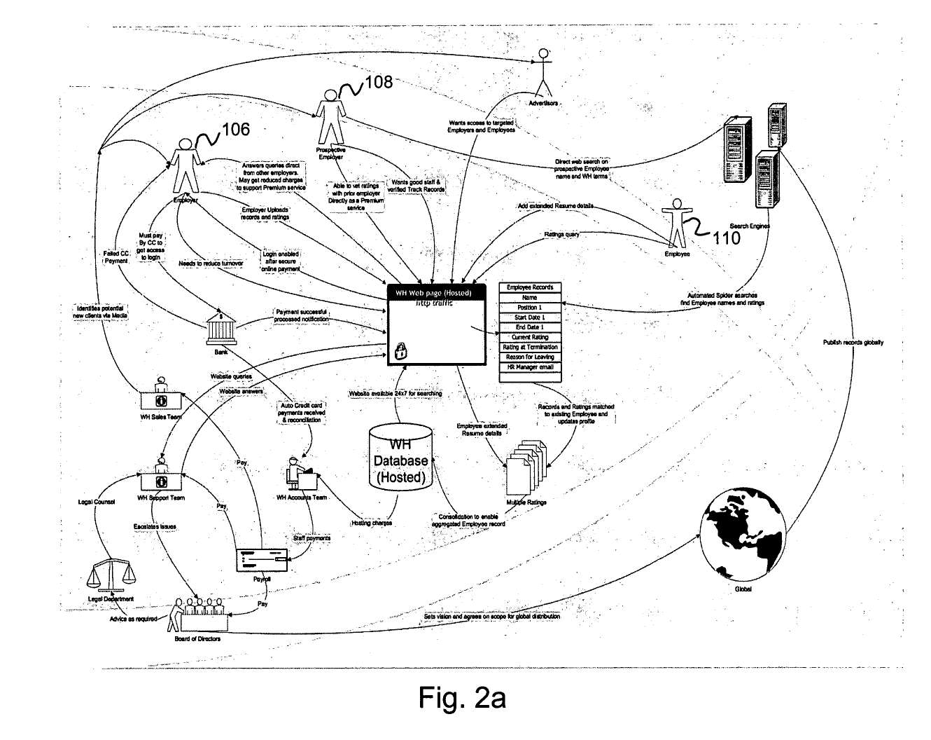

FIGS. 2a and 2b both show, at system level, various data flows between each of the different users and system elements, in accordance with an embodiment.

### Further Detail of System Elements

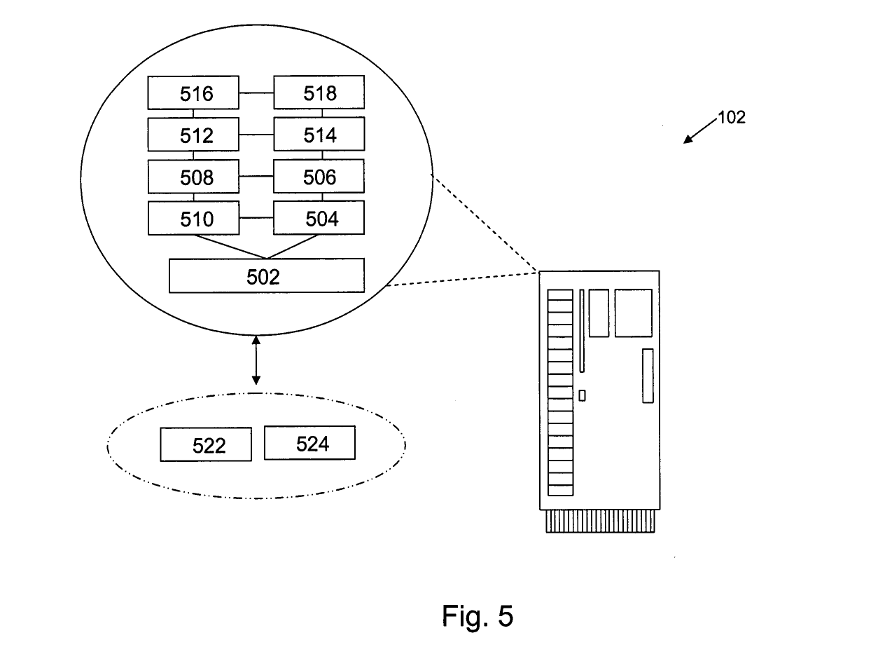

With reference to FIG. 5 there is shown a schematic diagram of a web server 102 suitable for use with an embodiment of the present invention. The web server 102 is in the form of a server computing system which may be used to execute applications and/or system services associated with storing, searching and retrieving employee records in/from the employee database 104. The server 102 preferably comprises a processor 502, read only memory (ROM) 504, random access memory (RAM) 506 and input/output devices such as disc drives 508, keyboard 510, mouse 512, display 514, printer 516 and communications device 518. The communications device 518 connects to the communication network 112. It will be understood that, depending on the communications network, the communications device may connect the web server 102 to a computer network, telephone line, an antenna, a gateway or any other type of communications network. Disc drives 508 may include any suitable storage media, such as, for example, floppy disc drives, hard drives, CD ROM drives or magnetic tape drives. The web server 102 may use a single disc drive 508 or multiple disc drives. In addition to the hardware, the server 102 also comprises an operating system, such as Windows™ or Unix™. The operating system provides an environment for executing software applications. In this regard, the server 102 implements a server application 522 comprising a recording module for recording employee records, a determination module for determining ratings (based on, where applicable, performance criteria stored in memory) and a publishing module for publishing the determined performance ratings, all of which interact to host the work history web site. The server 102 also implements a display module 526 programmed to control a graphical user interface displayed on the web site which allows users to access the employee database 104 (e.g. to create employee records, store performance data, search employees, search work wanted advertisements, etc). An example screen shot of a graphic user interface 600 provided by the web page is shown in FIG. 6. The determination module 524 (as previously described) is also included for determining the employee performance ratings/scores based on the performance data received from the employers (and optionally any bonus point criteria applicable). The determination module may also implement various algorithms for applying weightings to various scores or categories based on, for example, an importance factor assigned by the employer.

Employers 106, potential employers 108, employees 110, candidates 111 and any other authorised party can access the web server 102 using any form of network connected user computing device. The user computing device may be in the form of a personal computer comprising typical hardware and software for communicating over the network 112. A browser application residing on the personal computer is operable to allow a user to access the work history web page and interact with the user interface, as will be described in more detail below. It will be understood by persons skilled in the art that the user computing device may take the form of any computing device including a personal digital assistant (PDA), blackberry phone, a wireless computing system or any other suitable computing device.

### More Detail of Process Flows

### Creating Employee Work Ratings—

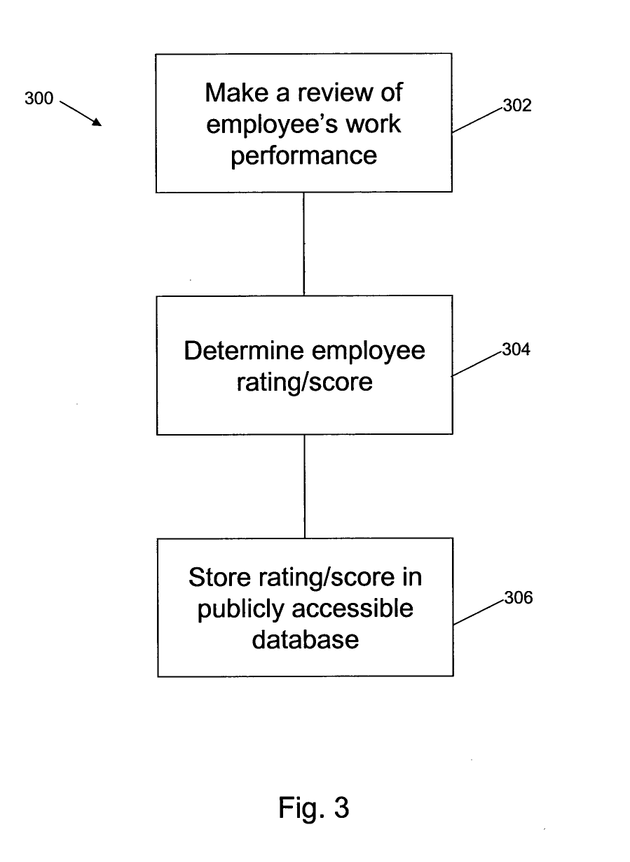

At FIG. 4 there is shown, in more detail, a process for creating and uploading work history data on the database 104. With reference to the top left hand portion of the process flow diagram 400, an employer 106 initially joins the work history system by accessing the web page (step 404). Once the employer 106 has provided sufficient enrolment data and paid the necessary licence fee (see steps 406 to 408), the employer 106 confirms employee details for all employees that have agreed (if required) to have their records and work history uploaded on the database 104 (steps 410 and 412). A user name and password may be provided to the employer 106 at this time for future access to the web server system.

At step 414, the employer 106 proceeds to make a review of each employee. In the illustrated embodiment, the review involves answering a series of multiple choice questions that are associated with the employee's work performance. The answers are processed by the determination module of the server application to calculate a star rating, as previously described (steps 416 through 422). In the illustrated embodiment, a five star rating means that the employee has achieved the highest work history score and therefore is a model employee. Once the rating has been calculated it is stored by the system in association with the employee record and optionally published (step 424). As mentioned above, step 424 may also involve storing the various questions and answers answered by the employer. In an embodiment, the ratings are indexed by searched engines such that a search based on the employee's identifier (e.g. name, work history ID, etc) will return their star rating and any other relevant data stored by the database (step 426).

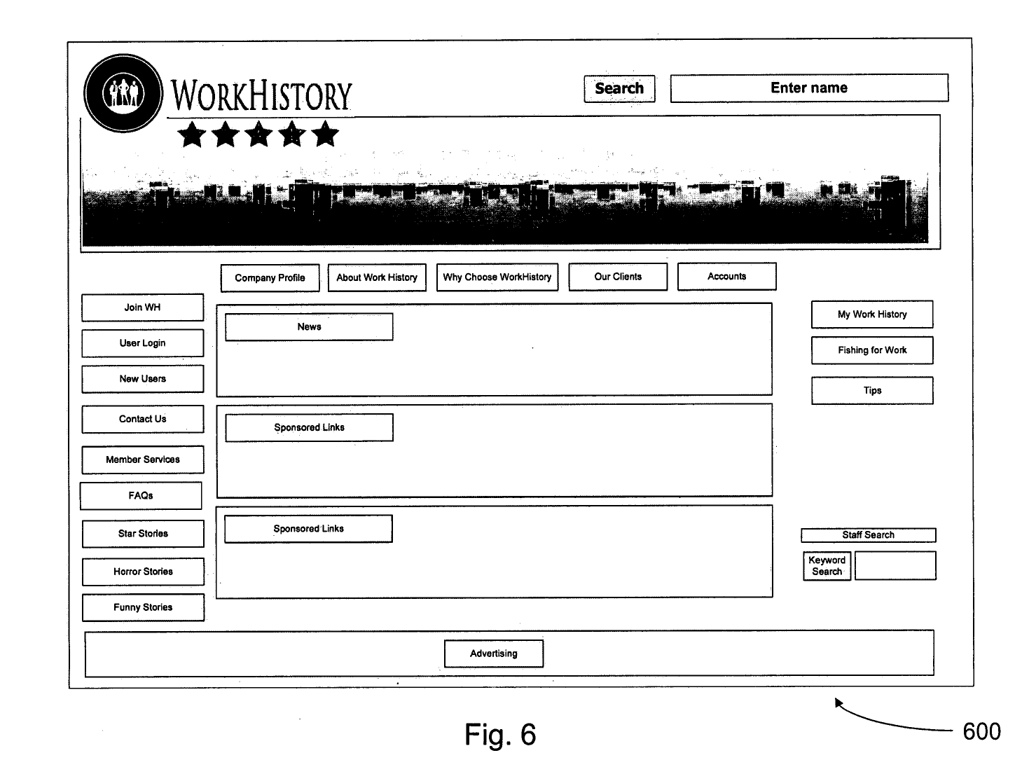

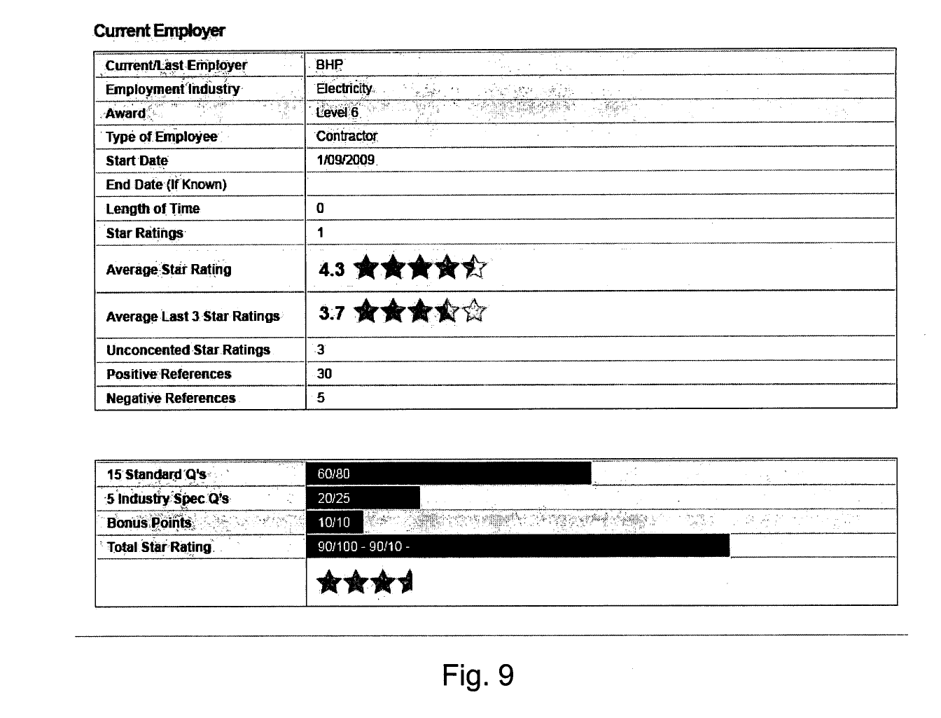

As new employees are recruited, existing employees have come up for review (e.g. as they end their probationary period), or at any suitable time, the employer 106 may log back into the web server (using their user name and password) to either create new employee records and ratings, or update existing records and ratings (See steps 430 to 434). For example, after a predetermined period (e.g. every three months) the employer may be required to update each employees work rating. In one embodiment, the web server 102 maintains a log as to when each performance assessment was last carried out and sends an automatic reminder (e.g. via e-mail) to the employer 106 when the predetermined period has expired. The employer 106 can log onto the system at any time to update the employee details to show that their employment has been terminated (see step 416). It will be understood that multiple ratings may be assigned by the one employer over the course of the employee's employment. This is an affective way of keeping an historical log of an employee's performance. A benefit of this is that employee's can learn from any negative rating and then improve on their rating over the course of employment. Another benefit is that the employee will have a well documented record of their work history for salary reviews and future employment. When a search is done on the employee, the web server 102 may be operable to show only the last rating applied, or show any number of historical ratings, depending on the desired implementation (see FIGS. 7 through 9 for example screen shots showing search results for a particular employee). For example, users searching the system may have to pay an additional fee in order to view the historical ratings.

It will also be understood that in certain embodiments, ratings or references may be given for a particular employee by persons other than their employer. For example, customers, clients and colleagues may make an evaluation of the employee's performance based on good or bad dealings they have had with the employee.

### Challenging Employee Ratings—

To ensure that the ratings applied by the currently and past employers are fair, the system includes a challenge mechanism whereby employees 110 can log on to the web server 102 at any time to challenge their rating. This process is shown at steps 440 through 444 (see middle left portion of process flow diagram 400). In an embodiment, the challenge mechanism involves requesting that the employer 106 review the rating (e.g. by considering and amending the answers previously given to the multiple choice questions). If the employee 110 is still unhappy with their rating, they can opt to have the dispute escalated to a neutral work history auditor. In an embodiment, independent legal counsel may be sought to resolve a disputed rating. Alternatively, the employee can simply not consent to having their rating published. This period will then show on the employee's work history record as either a non-rated or challenged period.

### Prospective Employees Seeking Work—

At any time a prospective employee (hereafter “candidate”) 111 can log onto the web server 102 and create a work wanted advertisement (see steps 450 to 454 shown in the bottom left quadrant of the process flow diagram 400). As previously mentioned, the candidate 111 may be out of work or still under the employ of an employer 106. In an embodiment, uploading a work wanted advertisement involves creating a new account and recording relevant details with the web server. Relevant details may include the candidate's personal identifier (which is utilised by the web server to retrieve any existing work history ratings stored in the database 104) and details of their desired job (e.g. start and end date, type of work, pay requirement and other relevant details). In an embodiment, the graphical user interface 600 provided by the web server may include a drop down box which includes a number of selections that the candidate 111 can choose from to create a work wanted advertisement. The candidate 111 also has the option of uploading their resume onto the database which is then stored in electronic format in association with their record. The work wanted advertisement is then posted on to the website at step 456. When setting up their account, the candidate also has the option of withholding their personal details from being displayed by the web server 102 in a search (i.e. such that only their capabilities and performance rating is displayed). If a potential employer wants to interview the candidate, the web server 102 notifies the candidate of the prospective employer's details (e.g. via an e-mail sent by the work history web server 102) so that they can organise a meeting. Alternatively, the candidate's profile, including contact details, will be made publicly available in the search such that the potential employer can directly contact the candidate.

### Prospective Employers Seeking Staff—

Prospective employers can search the work history database 104 to find suitable staff, utilising the graphic user interface 600. With reference to the bottom right hand section of the process flow diagram 400, this may involve the prospective employer 108 logging onto the web server 102 and creating an account (step 460 and 462). At step 464 the employer may be required to pay a fee to search the work history data base 104. The fee may, for example, allow the prospective employer 108 access to the database for a predetermined time period. It will be understood however, that other access rights and payment methods are equally suitable depending on the desired implementation.

At step 468, the prospective employer 108 searches the work history database 104 for candidates matching specified job requirements. Again, this might be achieved by selecting from a series of dropdown boxes which nominate different job descriptions, pay rates and the like. The server application 522 will subsequently search the database 104 for records which match the specified criteria and return the results to the prospective employer in a readily viewable format (e.g. in a list with records associated with the highest rating appearing at the top).

The prospective employer 106 can click on individual returned records to find out more about each candidate 111. For example, the additional detail may include the candidate's resume and other information provided by the candidate 111 when creating their advertisement. As mentioned above, certain data (such as historical candidate ratings) may be withheld depending on the access fee paid by the prospective employer 108. If the prospective employer 108 is impressed with the candidate and would like to arrange an interview, the prospective employer 108 can add the candidate to an electronic shopping trolley provided on the graphical user interface 600. At the end of their browsing session either (a) the candidate's contact details will be provided to the prospective employer and/or (b) conversely, the candidate will be notified of the prospective employers contact details (depending on the access restrictions set by the candidate, as mentioned above).

### Determining Star Ratings—

As previously described, the calculation of star ratings is automatically carried out by the determination application 524 of the web server 102. The calculation is based on responses to questionnaires completed by employers (or other authorised parties) and bonus point criteria stored in memory, if applicable. The calculation is initiated when a completed questionnaire is submitted using the graphical user interface, provided by the web server 102. An example scenario is provided below.

An employer answers a questionnaire for an employee in the electrical trade. Based on the input criteria for the particular employee, a questionnaire is automatically generated made up of fifteen standard questions and five industry specific questions (i.e. questions directly related to the performance of an electrical tradesperson). Based on the employer's responses to each of the 20 questions, a point score of 62 is recorded (see Table 1 below).

TABLE 1

| Question no. | Recorded Answer & Weighted Score |
|---|---|
| Q1 | E −> 5 points |
| Q2 | D −> 4 points |
| Q3 | C −> 3 points |
| Q4 | B −> 2 points |
| Q5 | C −> 3 points |
| Q6 | E −> 5 points |
| Q7 | D −> 4 points |
| Q8 | C −> 3 points |
| Q9 | B −> 2 points |
| Q10 | A −> 1 point |
| Q11 | E −> 5 points |
| Q12 | D −> 4 points |
| Q13 | C −> 3 points |
| Q14 | B −> 2 points |
| Q15 | A −> 1 points |
| Q16 | E −> 5 points |
| Q17 | D −> 4 points |
| Q18 | A −> 1 point |
| Q19 | B −> 2 points |
| Q20 | C −> 3 points |
| | Total score = Sum of specified response weight |
| | from 20 questions = 62 |

The determination application 524 subsequently evaluates bonus point criteria to determine a bonus point score. In the illustrated embodiment there are five bonus point assessments yielding a potential +/−10 bonus, as shown below.

### Assessment 1—Length of Stay

3 months and under=−2 points
3 month<Length of stay≦6 month=−1 point
6 month<Length of stay≦12 months=0 point
12 months<Length of stay≦24 months=1 point
Above 2 years=2 points

### Assessment 2—Number of Client/Colleague References

10 published references and under=−2 points
10<pub. references≦20 pub. references=−1 point
20<pub. references≦30 pub. references=0 point
30<pub. references≦50 pub. references=1 point
Above 50 pub. references=2 points

### Assessment 3—Number of Performance Star Ratings for a Particular Job Position Per Annum

2 star rating performances and under=−2 points
2<Star Rating Performances≦5=−1 point
5<Star Rating Performances≦8=0 point
8<Star Rating Performances≦11=1 point
Above 11 Star Rating Performances=2 points
   Assessment 4—Average Star Rating while Working for Current Employer
Under 2.5 Star Rating=−2 points
2.5<Star Rating≦3.5=−1 point
3.5<Star Rating≦4.0=0 point
4.0<Star Rating≦4.5=1 point
Greater than 4.5 Star Rating=2 points

### Assessment 5—Average Star Rating Across all Base Records

Under 2.5 Star Rating=−2 point
2.5<Star Rating≦3.5=−1 point
3.5<Star Rating≦4.0=0 point
4.0<Star Rating≦4.5=1 point
Greater than 4.5 Star Rating=2 points

By referencing associated data stored in association with the employee record, the determination application 524 determines that the employee has been employed for less than three months in their current role, has 50 published references generated by his colleagues, has five star ratings generated per annum, has an average star rating of 3.5 recorded by his current employer and an average star rating across all base records of 3.56. Thus, by evaluating the bonus point criteria, the determination application 524 automatically determines a bonus point score of −1, resulting in a total point score of 61 for the employee. The total point score is then divided by 20 to give an employee star rating of 3 stars (rounded to the closest whole number).

It will be appreciated that the number of bonus points available as well as the actual criteria used to evaluate the bonus point score may vary, depending on the desired implementation.

### Graphical Representation of Work History Records—

It is important that an employee's work history (and star ratings) are displayed in a manner such that they are quickly and readily interpreted by users of the system 100. To achieve this function, and with reference to FIG. 7, the display module 526 implemented by the work history server 102 is configured to display the ratings in a chart-format operable to show all of the records created for a specific employee by current/former employers (or by the employee themselves).

As illustrated, the work history records are displayed in blocks in the graphical chart. The older records are displayed on the left section of the chart, while the newer records are displayed towards the right-hand section (i.e. in a timeline-based fashion). A user can navigate back or forward to view the records for any particular period of time. The Y axis displays the average star rating corresponding to the work history record block. As can be seen from FIG. 7, a number of blocks are shown without any particular star rating (i.e. displayed under the “0” star rating line). This may be because the job position was a non-rateable position (e.g. a voluntary position, etc.), a period of unemployment, or due to the employee licence being invalid as will be described in more detail in subsequent paragraphs. In the illustrated embodiment, the blocks are colour-coded to reflect further information about the rating (in this case whether the record has been verified by the employer). If any of the work history records overlap, the display module 526 is programmed to flag them as such and allow a user to click on the block to show the individual ratings and associate attributes (e.g. employer, job type, etc.). When a particular block is selected, the following data is presented in a pop-up screen:
employment type (full-time/part-time/permanent part-time/contractor/sole-trader/volunteer)
reason for leaving (if employee is no longer working in the job position)
job position
start and end date of job position
date of star rating
average star rating for the base record
linked reference reports from the employee's colleagues and clients
number of star ratings generated up to the present for the selected job position
number of star ratings generated up to the present for all base records

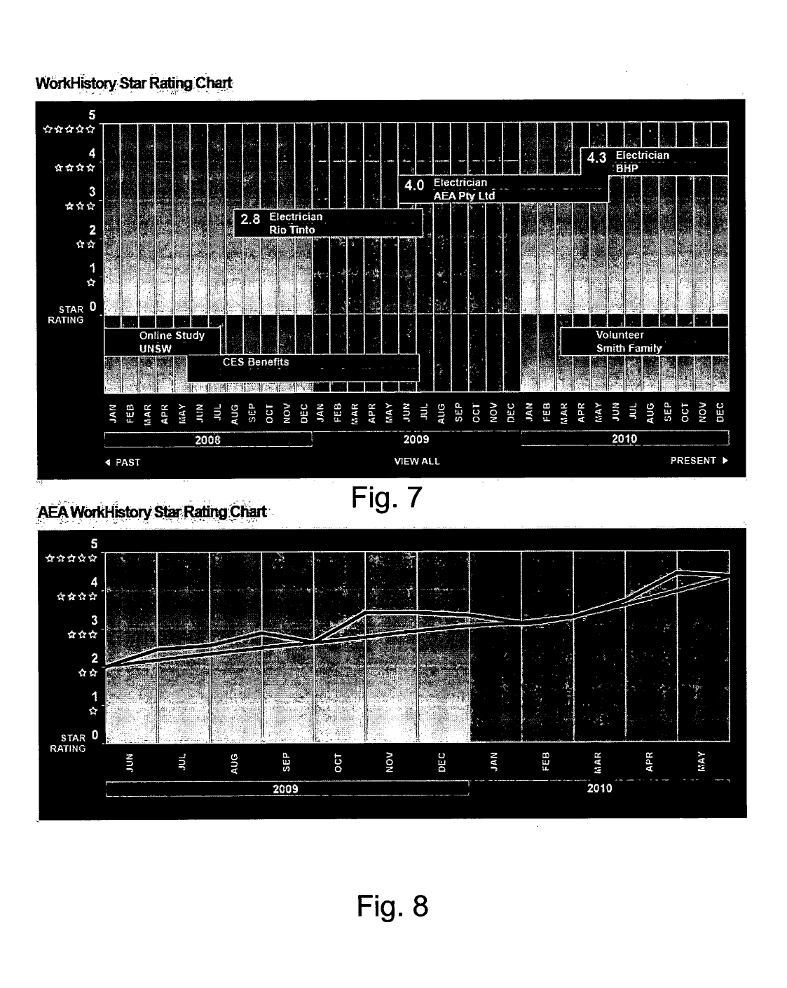

The display module 526 is also arranged to automatically plot and display on the user interface an average star rating for the employee over a selected period, as shown in FIG. 8.

### Licences—

The system 100 is configured to issue licences to employers which in turn allows the employers to use the system (i.e. generate and review star ratings for employees). If the licence expires (e.g. due to the employer not paying a licence fee when required), the employee's record, during the time period of which the employee does not have a valid licence, will be displayed under the ‘0 star rating’ on the y-axis until a valid licence is assigned to the employee.

By way of example, the employer purchases a standard subscription with say 20 employee licences from WorkHistory system 100 (e.g. using the web interface). These licences will only become valid when the subscription payment is cleared and confirmed by the system 100. With a valid employee licence, star ratings can be generated for up to 20 employees.

The assignment of a licence to a specific employee is done at the point of creation of the WorkHistory record (i.e. base record) for the employee.

Star ratings can now be performed on the employee and in the context of the chart, the average star rating will be calculated for the WorkHistory record. As the employee still has a valid employee licence, the WorkHistory record will be displayed at the level of the average star rating and set as the time period for which the WorkHistory record exists.

If the employee's licence expires (i.e. all star ratings have been performed, or the licence period has gone beyond the 12 months valid period) but the employee is still working in the same job position and for the same employer, the employee star record will be displayed under the ‘0 star rating’ for the time period of which the licence is expired.

### Other Features and Functions

In an embodiment, the web page may include a link to funny, horror and star stories based on real life scenarios. For privacy reasons, the stories may not identify the actual employees who are the subject of the real life scenarios. The stories may be added by employers, prospective employers, or employees alike, to illustrate the effectiveness of the system.

In an embodiment, the web server 102 may be operable to store additional referee data associated with an employee. The additional referee data may include personal or work references that have been added to the database (e.g. at the request of the employee, or independently by the referee). By way of example, a housekeeper works away quietly and capably, doing his duties. The housekeeper has not received any complaints by guests, nor does management have any real issues with his performance. Based on an appraisal by his employer, he is assigned a four star performance rating. However the guests (customers) are able to reward the housekeeper by posting a favourable comment (i.e. in the form of referee data) on the web server 102, which is subsequently stored in association with the employee's profile. Colleagues and the like can do similar and post support for others. The postings assist in better understanding the employee's performance and, although not forming part of the rating, may provide another means of judgement (e.g. such as being used in assessing bonus points as previously described).

In an embodiment, categories or performance characteristics derived from the questionnaire may include:

1) punctuality to work and commencement of work
2) time at work
3) hardworking
4) handling of stress or pressure

### 5) Presentation

6) Recommendation of the employee to others
7) re-employ
8) vices or addictions
9) work unsupervised
10) completion of tasks
11) serious breaches
12) personality
13) honesty
14) integrity
15) ability to work with others
16) company pride
17) health and wellbeing
18) reliability
19) improvement
20) current status

In an embodiment, advertisers can pay a fee to have their advertisements displayed on the web page in accordance with techniques known in the art (see step 480).

Finally, it will be understood that embodiments may equally apply for other non-work based evaluations for any particular entity. For example, the general system configuration and method of recording ratings could be applied to the following non-limiting applications:

Rental History (i.e. Residential Tenancies and Leases):

According to the rental history embodiment, the system may be configured to provide a star rating for tenants (lessees) of either residential, commercial, or any other type of property. The star rating again would be generated based on an online questionnaire answered by a lessor or lessor's agent (owner or agent), in addition to any bonus point evaluations that form part of the assessment, via the online web interface. The questionnaire and bonus points are designed to evaluate how desirable the tenant is and apply a star rating to that tenant, be it for a periodical inspection, or on termination of the tenancy. The rental history of a tenant may also be recorded by the online system and be accessible by any future or prospective lessor or agent in determining if that tenant is suitable.

### Typical Questionnaires May be Used to Evaluate the Following Non-Limiting Criteria:

Promptness of rental payment
Maintenance of subject property (external and/or internal)
Promptness in dealing with maintenance issues
Have they been a nuisance to or disturbed the neighbours
Do they comply with lease conditions
Have they ever broken any lease conditions or by laws
Condition on vacation/inspections etc.

Bonus point criteria may relate to length of stay in a particular property, no of positive references, evaluation of previous star ratings, etc. All of the bonus point criteria are automatically evaluated by the system when establishing the star rating, as previously described for the work history embodiment.

### Guest History (Hotel and Serviced Apartment Stays):

This embodiment evaluates and applies a star rating to a guest of a hotel, motel, serviced apartment accommodation, or the like. The same evaluations apply as for the work history embodiment, but with questions related to the behaviour and desirability of a guest. The questionnaire is completed by the owner, manager, or operator of the premises using the online web interface. Guest History will allow an owner, manager or operator to selectively check that the guest they are to provide accommodation for is suitable and can choose to accept or deny the accommodation based on their star rating.

### Typical Questions and Answer Topics May Include, but are Not Limited to, the Following:

Condition of room or apartment when vacated
Return of keys
Noise levels
Payment
Extra services payment (i.e. mini bar etc)
Behaviour of guest's invitees
Any damages to the subject property

### Love History (Rating of Current or Past Partners, Lovers, Etc.):

According to this embodiment, the system is configured to allow a person to evaluate their partner and have the system automatically generate a star rating which is reflective of the relationship as scored/seen by the partner who does the rating. In one aspect, the love history system allows honest evaluations of a relationship between partners (or other parties where authorised), with the aim of either improving the relationship or, where the rating is made public, notify others of that person's love history (whether good or bad).

### Business History/Company History (Rating Companies):

According to this embodiment, the system is configured to provide a star rating for companies or businesses as a whole. The star rating is again based on responses to a questionnaire (together with bonus point criteria relating to, for example, number of positive references by other companies, etc.) provided by businesses or individuals who have interacted or done business with that company. As with all of the other applications, the business history of a company can be used by prospective entities planning to be involved with the business.

### Typical Questions and Answer Topics May Include, but are in No Way Limited to the Following:

Promptness of response to enquiry
Were company representatives accessible at all times
Can representatives be accessed via email
Were company representatives courteous and agreeable
Is the company accessible over the internet
Was the company able to provide the services/products that they advertised
Were their services/products of sound quality
Were the company's offices easy to access

### Credit History:

According to the credit history embodiment, the system may be configured to evaluate and provide a star rating for individuals, businesses or other entities in relation to credit performance. The questionnaire may be completed online using the web interface by the financier (e.g. mortgagor, creditor etc.) and bonus points relating to length of the loan, client references, etc., may also be evaluated. An advantage of such an embodiment is that individuals (or other entities) with both good and bad credit histories will be listed. The question and answer topics may include, but are not limited to:
Service ability
Timeliness of payments
Adherence to contract
Repayments in full

It will be understood that in alternative embodiments to those described above, the system may be configured to automatically combine ratings of an individual or entity. For example, an overall individual rating may combine (or show independently) work history, love and credit history ratings. The combined rating may simply be an average of all of the separate ratings or applying a weighting to particular ones of the ratings, depending on the desired implementation.

It will also be understood that in some, or all of the above embodiments, the system may require the assessor (i.e. the entity generating the rating) to gain consent from the assessee (i.e. the entity for which the rating is being generated) before the rating can be uploaded or made publicly available by the system. In an embodiment, the assessee may provide authorisation for only selected parties to view their rating (see below for more detail).

According to both embodiments, the web server 102 maintains a consent field in memory 506 which stores the level of consent and references this data before a search is carried out, to ensure that ratings are not made publicly available where consent has not been given.

In still a further embodiment, before a record can be accessed, the entity looking to access and review the record must first obtain consent from the web server system 102 (or alternatively directly from the entity associated with the record). In one embodiment this is achieved by sending an email to the web server 102 using a pin number associated with the record. Upon the web server 102 providing consent, the searcher will then be allowed access to the associated ratings page.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A computer system for providing employee performance ratings, the system comprising:
a storage module configured to store an employee record comprising:
employee performance data generated in response to an evaluation made by an associated employer and by a party other than the associated employer; and
a bonus point score associated with an employee performance parameter, wherein the bonus point score is generated independently of the evaluation made by the associated employer and the party other than the associated employer; and
a determination module arranged to evaluate both the stored employee performance data and bonus point score to determine a performance rating for the employee; and
a web server arranged to make the determined performance rating available to third parties over the Internet, wherein the web server is further arranged to display a relationship between the performance rating and the associated employer or the party other than the associated employer that made the evaluation,
wherein the storage module is configured to store employee records comprising performance data provided by a plurality of different associated employers and a plurality of different parties other than the associated employer for use by the determination module in determining performance ratings particular to each of the different employers and each of the different parties other than the associated employer.

2. A system in accordance with claim 1, wherein the evaluation made by the associated employer evaluates at least one performance characteristic.

3. A system in accordance with claim 2, being further configured to automatically generate a questionnaire for completion by the employer based on an employee job characteristic, the questionnaire forming at least part of the evaluation.

4. A system in accordance with claim 3, wherein the automatically generated questionnaire includes at least one question which is specific to the job characteristic.

5. A system in accordance with claim 3, wherein the questionnaire includes multiple choice questions with each answer being assigned a particular score, the performance data reflecting answers to the questionnaire.

6. A system in accordance with claim 5, wherein the employee performance parameter includes at least one of:
a) a period of employment with the associated employer
b) a number of references provided by parties other than the associated employer;
c) a number of positive performance ratings associated with the employee record;
d) an average performance rating for the employee by the same and/or different associated employers.

7. A system in accordance with claim 6, wherein the performance rating is derived from the scores resulting from the questionnaire and the bonus point score.

8. A system in accordance with claim 2, wherein the performance characteristics vary depending on at least one of the employee's job type, pay level and duration of employment.

9. A computer implemented system for making employee performance evaluations, the system comprising:
a data recording module operable to record results of an employee performance evaluation, wherein the employee performance evaluation is made by at least one associated employer or at least one party other than the associated employer; and
a communications module operable to communicate the recorded results as performance data to a centralised computing system for determining a performance score based on both the recorded results and bonus point data which is generated independently of the employer performance evaluation and associated with an employee performance parameter, the performance score being published on a website accessible over the Internet.

10. A system in accordance with claim 9, wherein the employee performance parameter includes at least one of:
a) a period of employment with the associated employer
b) a number of references provided by parties other than the associated employer;
c) a number of positive performance ratings associated with the employee record;
d) an average performance rating for the employee by the same and/or different associated employers.

11-39. (canceled)

40. A computer system for providing employee performance ratings, the system comprising:
a storage module configured to store an employee record comprising:
employee performance data generated in response to an evaluation made by an associated employer; and
a bonus point score generated independently of the employer evaluation and associated with an employee performance parameter; and
a determination module arranged to evaluate both the stored employee performance data and bonus point score to determine a performance rating for the employee; and
a web server arranged to make the determined performance rating available to third parties over the Internet,
wherein the storage module is configured to store employee records comprising performance data provided by a plurality of different associated employers for use by the determination module in determining performance ratings particular to each of the different employers.

41. A system in accordance with claim 40, wherein the evaluation made by the associated employer evaluates at least one performance characteristic.

42. A system in accordance with claim 41, being further configured to automatically generate a questionnaire for completion by the employer based on an employee job characteristic, the questionnaire forming at least part of the evaluation.

43. A system in accordance with claim 42, wherein the automatically generated questionnaire includes at least one question which is specific to the job characteristic.

44. A system in accordance with claim 42, wherein the questionnaire includes multiple choice questions with each answer being assigned a particular score, the performance data reflecting answers to the questionnaire.

45. A system in accordance with claim 44, wherein the employee performance parameter includes at least one of:
a) a period of employment with the associated employer
b) a number of references provided by parties other than the associated employer;
c) a number of positive performance ratings associated with the employee record;
d) an average performance rating for the employee by the same and/or different associated employers.

46. A system in accordance with claim 45, wherein the performance rating is derived from the scores resulting from the questionnaire and the bonus point score.

47. A system in accordance with claim 41, wherein the performance characteristics vary depending on at least one of the employee's job type, pay level and duration of employment.
